(19) United States
(12) Patent Application Publication
(10) Pub. No.: US 2026/0155558 A1
(43) Pub. Date: Jun. 4, 2026

(54) VEHICLE ANTENNA

(71) Applicant: FUBA Automotive Electronics GmbH, Bad Salzdetfurth (DE)

(72) Inventors: Joshua Weichenhain, Bockenem (DE); Balint Kurucz, Zalaegerszeg (HU)

(21) Appl. No.: 19/402,707

(22) Filed: Nov. 26, 2025

(30) Foreign Application Priority Data
Dec. 3, 2024 (DE) 102024135859.9

(51) Int. Cl. H01Q 1/32; H01Q 1/12; H01Q 1/42

(52) U.S. Cl. CPC H01Q 1/32; H01Q 1/1221; H01Q 1/42

(57) ABSTRACT

A vehicle antenna has a housing having a peripheral seal, wherein a plurality of spring clips are provided at the underside of the housing.

The present invention relates to an antenna for a vehicle, said antenna having a housing that has a seal extending peripherally at its margin.

Such antennas are, for example, generally known in the form of roof antennas and are usually fastened in an opening of a vehicle body via a screw connection.

It is the object of the present invention to provide a vehicle antenna that can be manufactured particularly cost-effectively and that can in particular be assembled without tools in a short time.

This object is satisfied by the features of claim 1 and in particular by a vehicle antenna that can be assembled without tools and that has a housing having a seal extending peripherally at its margin, wherein a plurality of spring clips, with which the housing can be clipped into a body opening in a sealing manner, are arranged at an underside of the housing. The spring clip has a loop section, in particular a U-shaped loop section, that is open towards an underside of the housing.

The vehicle antenna according to the invention can be manufactured very cost-effectively since no clamping brackets, counter holders, screw connections or the like are required for the assembly of the vehicle antenna. Due to the seal extending peripherally at the outer margin of the housing, it is achieved in combination with the spring clips that, after a clipping of the vehicle antenna into the body opening, no liquid or moisture can enter through the body opening. At the same time, the assembly is very quick and simple since the vehicle antenna, or its housing, only needs to be pressed into the body opening, whereupon the vehicle antenna is held in a fixed and sealed manner in the body opening. Due to the loop section that is open towards the underside of the housing, the housing can in this respect be inserted into the body opening without tools but in a sealed manner. The loop section can furthermore serve as a sliding surface when inserting the vehicle antenna into the body opening.

Advantageous embodiments of the invention are described in the description, in the drawing, and in the dependent claims.

In a first advantageous embodiment, the spring clips can be manufactured in one piece with a base plate composed of metal. Such an embodiment not only enables a cost-effective manufacture, but also an electrically conductive connection between the antenna, the base plate, all the spring clips and the body since the spring clips contact the margin of the body opening after the antenna has been assembled, and thereby establish an electrical contact.

According to a further advantageous embodiment, the base plate can be a stamped and bent part, which results in low manufacturing costs.

According to a further advantageous embodiment, the base plate can be polygonal in a plan view, for example square or approximately triangular, with at least one spring clip being present at each side of the base plate. In principle, the base plate can have any shape, for example, also a circular shape or an approximately rectangular shape with at least one rounded narrow side. Due to a provision of at least one spring clip at each side, a secure assembly is in this respect guaranteed in every case. In the case of approximately circular or oval base plates, a uniform spacing apart of the spring clips along the periphery can be advantageous.

According to a further advantageous embodiment, at least one engagement recess, into which a tool can be introduced for the dismantling of the vehicle antenna, can be present at an upper side of the housing. A screwdriver can hereby, for example, be introduced into the engagement recess for the dismantling of the vehicle antenna, with which screwdriver the vehicle antenna can be levered out of the body opening. It can be advantageous here if the vehicle antenna can be reversibly assembled in a body opening, i.e. it can be removed from the body opening again after the assembly has taken place without damaging the vehicle antenna or the vehicle.

According to a further advantageous embodiment, a surface section of the housing can be designed as an abutment surface for a respective spring clip, wherein each spring clip is supported at the housing. The spring clips can hereby be manufactured from a comparatively thin material since, after the insertion of the vehicle antenna into a body opening, the abutment surface ensures that the spring clips cannot be bent any further in the region of the abutment surface. The abutment surface hereby exerts a counterforce on the adjacent spring clip. Said spring clip then only needs to be dimensioned such that the spring force, which is exerted by the spring clip itself, holds the vehicle antenna in a fixed and sealed manner in the body opening.

According to a further advantageous embodiment, the loop section can have a punched-out portion that is in particular surrounded at all sides by the material of the spring clip. The spring clip is hereby deliberately weakened in the region of its loop to enable a better bending behavior and thus an easy insertion of the vehicle antenna into the body opening.

According to a further advantageous embodiment, the free end of at least one spring clip can in particular be kinked multiple times in the direction of the housing. The spring clip can hereby be produced during its manufacture such that its free end slides along the margin of the opening on a first insertion of the vehicle antenna into a body opening and is compressed to the maximum on a further insertion at a kink point and then relaxes again slightly.

It can furthermore be advantageous here if at least one spring clip has three or more planar surface sections that adjoin one another at an angle and that cause a different compression of the spring clip during the insertion of the vehicle antenna into the body opening.

According to a further advantageous embodiment, a particularly good fastening of the vehicle antenna can take place in that at least one spring clip is present at each side of the base plate and at least two spring clips are present at two oppositely disposed sides in each case.

According to a further advantageous embodiment, the seal can represent the only seal of the vehicle antenna, wherein the seal can in particular be made of silicone foam. Such a material has proven to be particularly advantageous in order to ensure a good sealing, on the one hand, and an easy insertion of the antenna, on the other hand.

According to a further aspect of the present invention, the invention also relates to a vehicle comprising a vehicle antenna of the kind described above. Furthermore, it is understood that the vehicle antenna described herein is naturally also suitable for aircraft and watercraft.

The present invention will be described in the following purely by way of example with reference to an advantageous embodiment and to the enclosed drawings. There are shown:

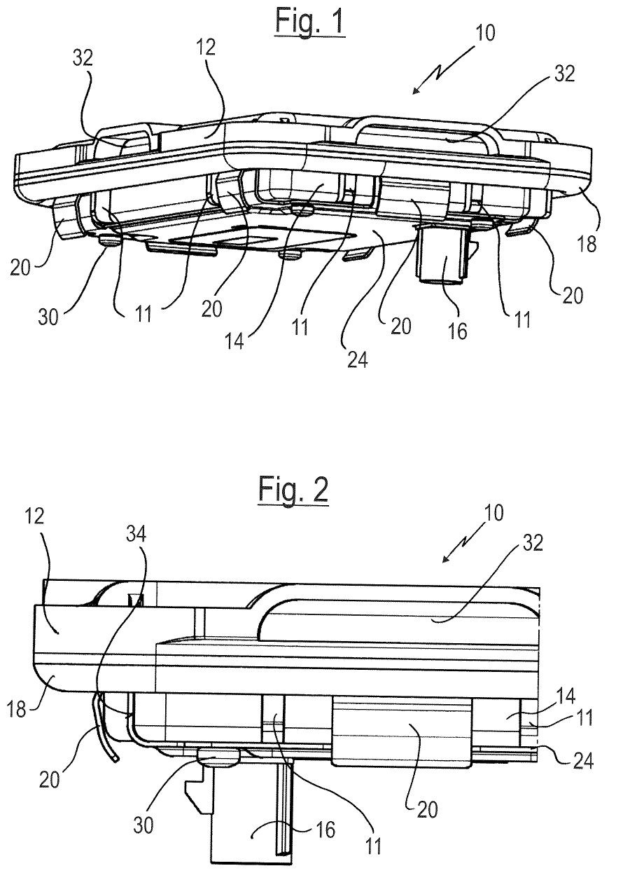

### FIG. 1 A PERSPECTIVE VIEW OF A VEHICLE ANTENNA;

FIG. 2 an enlarged side view of the vehicle antenna of FIG. 1;

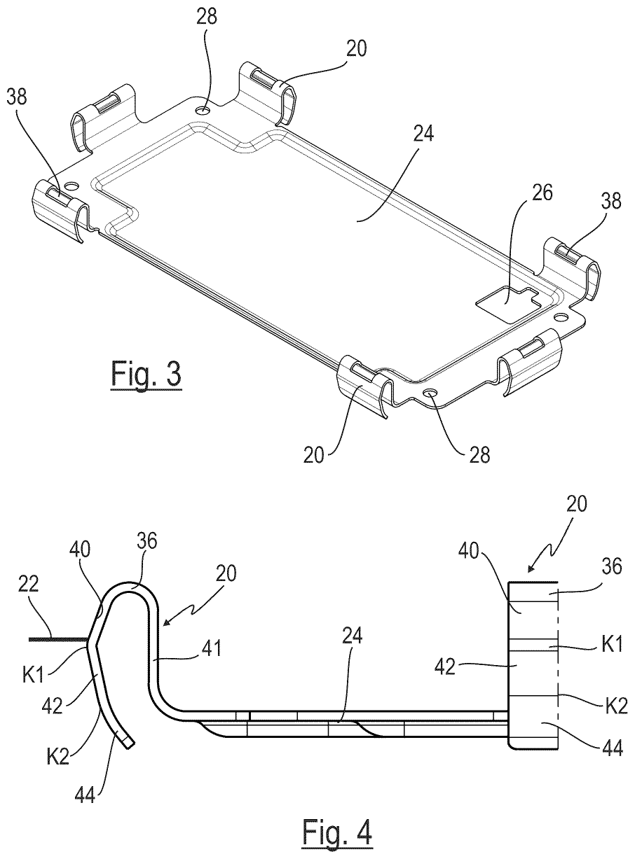

FIG. 3 a perspective view of the base plate of the vehicle antenna of FIGS. 1 and 2; and

FIG. 4 an enlarged part view of the base plate of FIG. 3 that is inserted into a body opening.

FIG. 1 shows a vehicle antenna that can in particular be assembled without tools and that has a housing 10 that comprises an upper part 12 and a lower part 14 that are fixedly connected to one another, for example, screwed or clipped together. Electrical and/or electronic components of the antenna can be located in the interior of the housing 10, wherein an antenna connection 16, via which the antenna signal can be conducted out of the housing, is provided at the underside of the lower part 14.

As FIG. 1 and FIG. 2 show, the upper part of the housing 12 projects slightly beyond the outer margin of the lower part 14, wherein, in the region of the transition between the upper part 12 and the lower part 14, a peripheral seal 18 is present that extends at the outer margin of the housing 10 and in particular extends between the outer periphery of the upper part 12 and the outer periphery of the lower part 14. The seal 18 can, for example, be made of silicone foam. In particular, the seal 18 can also be manufactured in one piece with the housing 10, and in particular with the upper part 12, in a two-component process. The reference sign 11 refers to centering ribs arranged along the periphery of the housing 10.

In the embodiment example shown, at its outer margin, the seal 18 does not project beyond the housing 10 or the upper part 12. Rather, the seal 18 is formed flush at the transition between the upper part 12 and the seal 18.

Furthermore, at its underside, the housing 10 is provided with a plurality of spring clips 20 with which the housing 10 can be clipped into an opening of a body 22 in a sealing manner (FIG. 4). The spring force of the spring clip 20 is directed away from the housing 12 in this respect.

In the embodiment example shown, the vehicle antenna is rectangular in a plan view, with two spring clips 20 being provided at the two longitudinal sides of the vehicle antenna and a spring clip 20 being provided at each of the narrow sides. In the embodiment example, all the spring clips 20 are U-shaped and, with a downwardly open loop section, are manufactured in one piece with a base plate 24 that is composed of metal and that is configured as a stamped and bent part. As is in particular illustrated by FIG. 3, the base plate 24 has a recess 26 for the antenna connection 16 and a plurality of openings 28 through which assembly screws 30 can be guided in order to screw the base plate 24 to the housing 10.

Due to the base plate 24 screwed to the housing 10, the antenna described above can easily be clipped into an opening of a body 22 in a sealing manner by pressing the antenna into the opening of the body 22 from above. As a result, all the spring clips 20 are initially pressed inwards in the direction of the housing 12, wherein they spring back again slightly after a complete insertion and thereby hold the vehicle antenna in a fixed and sealed manner in the opening of the body 22. In this respect, the spring clips contact the body 22 at the margin of the body opening, on the one hand. This state is shown in FIG. 4. On the other hand, each spring clip 20 is supported at the housing 10 with the part of the loop section 36 that originates from the base plate 24.

In order to enable a reversible assembly and a non-destructive dismantling of the vehicle antenna, in the embodiment example shown, a plurality of engagement recesses 32 are provided, into which a tool, for example a screwdriver, can be introduced for the dismantling of the vehicle antenna. In the embodiment example shown, engagement recesses 32 are present at all four sides of the upper part 12, wherein their openings are each oriented in the direction of the periphery of the housing 10. By introducing one or more screwdrivers into engagement recesses, the antenna can be easily levered out of the body opening again.

As already mentioned above, all the spring clips 20 are initially compressed on the insertion of the vehicle antenna into the body opening. In order to prevent the spring clips 20 from springing away too much here, the housing 10, in particular the lower part 14 of the housing 10, has a surface section 34 (FIG. 2) behind each spring clip 20 in each case, said surface section serving as an abutment surface for the adjacent spring clip 20. On an insertion of the vehicle antenna into the body opening, only the free arm, which is the outer arm in FIG. 4, of the spring clip 20 that is generally bent in a U shape is hereby bent, whereas the right arm, which is connected to the base plate 24 and which is substantially planar, contacts the lower part 14.

FIG. 4 shows a spring clip 20 in a side view (at the left) and in a plan view (at the right), respectively. As can be seen, the spring clips 20 are generally U-shaped and are bent into a loop 36, wherein the U opens in the direction of the underside of the base plate 24. The loop section 36 forming the upper side of the spring clip 20 has, at its center, an approximately rectangular punched-out portion 38 (FIG. 4) that is surrounded at all sides by the material of the spring clip 20. Furthermore, the free end, i.e. the left arm of the spring clip 20 in FIG. 4, is kinked multiple times in the direction of the housing 10. Thus, following the loop section 36, the spring clip 20 shown initially has a planar surface section 40 that is adjoined by a first kink point K1. At said first kink point K1, the spring clip 20 is kinked in the direction of the housing 10 so that it is adjoined by a second planar surface section 42 that merges via a second kink point K2 into a third planar surface section 44. Here, in the unassembled state, the angle between the inner arm 41 and the first planar surface section 40 can amount to approximately 18° to 22°, in particular approximately 20°, and the angle between the first planar surface section 40 and the second planar surface section 42 can amount to approximately 28° to 32°, in particular approximately 30°. The angle between the second planar surface section 42 and the third planar surface section 44 can amount to approximately 28° to 32°.

It is understood that the specific embodiment of the vehicle antenna described above is purely exemplary and that the housing 10 can in principle have any desired shapes.

1-11. (canceled)

12. A vehicle antenna that can be assembled without tools, comprising
a housing, which has a seal extending peripherally at its margin, and a plurality of spring clips which are arranged at an underside of the housing and with which the housing can be clipped into a body opening in a sealing manner, wherein the spring clips have a loop section that is open towards an underside of the housing.

13. The vehicle antenna according to claim 12,
wherein a surface section of the housing is configured as a contact surface for a respective spring clip and each spring clip is supported at the housing.

14. The vehicle antenna according to claim 12,
wherein the free end of each spring clip is kinked multiple times in the direction of the housing.

15. The vehicle antenna according to claim 12,
wherein each spring clip has three planar surface sections adjoining one another at an angle.

16. The vehicle antenna according to claim 12,
wherein a punched-out portion is present in the loop section.

17. The vehicle antenna according to claim 16,
wherein the punched-out portion is surrounded at all sides by the material of the spring clip.

18. The vehicle antenna according to claim 12,
wherein the base plate is quadrangular in a plan view, wherein at least one spring clip is present at each side of the base plate, and wherein at least two spring clips are present at two oppositely disposed sides in each case.

19. The vehicle antenna according to claim 12,
wherein at least one engagement recess, into which a tool can be introduced for the dismantling of the vehicle antenna, is present at an upper side of the housing and above the seal.

20. The vehicle antenna according to claim 12,
wherein it can be reversibly assembled in a body opening.

21. The vehicle antenna according to claim 12,
wherein the seal is the only seal of the vehicle antenna.

22. The vehicle antenna according to claim 21,
wherein the seal is made of silicone foam.

23. The vehicle antenna according to claim 12,
wherein the spring clips are manufactured in one piece with a base plate that is composed of metal and that is a stamped and bent part.

24. A vehicle comprising a vehicle antenna comprising a housing, which has a
seal extending peripherally at its margin, and a plurality of spring clips which are arranged at an underside of the housing and with which the housing can be clipped into a body opening in a sealing manner, wherein the spring clips have a loop section that is open towards an underside of the housing that is inserted into an opening of a body of the vehicle.
